(19) United States
(12) Patent Application Publication
(10) Pub. No.: US 2023/0011097 A1
(43) Pub. Date: Jan. 12, 2023

(54) MAGNETIC MATERIAL FOR A WIRELESS CHARGING SYSTEM AND A METHOD FOR MANUFACTURING SAME

(71) Applicants: HYUNDAI MOTOR COMPANY, Seoul (KR); KIA CORPORATION, Seoul (KR)

(72) Inventor: Youngmin Kim, Siheung-si (KR)

(73) Assignees: HYUNDAI MOTOR COMPANY, Seoul (KR); KIA CORPORATION, Seoul (KR)

(21) Appl. No.: 17/734,800

(22) Filed: May 2, 2022

(30) Foreign Application Priority Data
Jul. 8, 2021 (KR) 10-2021-0089458

(51) Int. Cl. H02J 50/00; H01F 41/02; H01F 1/147

(52) U.S. Cl. CPC H02J 50/005; H01F 41/0246; H01F 1/1475

(57) ABSTRACT

A magnetic material for a wireless charging system comprises iron powders and 1-10% by weight of a thermosetting resin. The iron powders are individually insulated by the thermosetting resin. A method for manufacturing the magnetic material for the wireless charging system includes mixing particles of a balance of the iron powders, pressing the mixed particles of the iron powders and the thermosetting resin, and subjecting curing heat treatment to a green compact, where the iron powders are individually insulated by the thermosetting resin.

### CROSS-REFERENCE TO RELATED APPLICATION

This application claims priority to and the benefit of Korean Patent Application No. 10-2021-0089458 filed in the Korean Intellectual Property Office on Jul. 8, 2021, the entire contents of which are incorporated herein by reference.

### BACKGROUND

### (a) Field of the Disclosure

An embodiment of the present disclosure relates to a magnetic material for a wireless charging system, which has excellent magnetic properties as a general-purpose material to increase charging efficiency and has excellent molding strength, and a method for manufacturing the same.

### (b) Description of the Related Art

As smartphones become more popular and electric vehicles are spotlighted, interest has increased in wireless power transmission technology, which can freely charge batteries anytime, anywhere without a wired charger.

The wireless power transmission technology refers to a technology, which transfers power energy from a transmitter to a receiver (terminal) using the induction principle of a magnetic field.

The wireless power transmission technology is classified into a magnetic induction method, a magnetic resonance method, and an antenna method (radiation method) depending on the transmission method and distance.

Regardless of which method is adopted, the basic concept of wireless power transmission consists of a transmitter, which transmits power, and a receiver, which receives the transmitted power. The transmitter and receiver have a structure similar to a transformer and consist of a coil and a magnetic material.

The magnetic material used at this time serves to shield magnetism and reduce electrical resistance.

The magnetic shielding of the magnetic material provides a low impedance path with respect to the magnetic flux, reduces magnetic field lines emitted to the outside, reduces the effect of the magnetism on surrounding metal objects, and prevents eddy currents and signal interference.

Further, the magnetoresistance reduction of the magnetic material improves the coupling coefficient, improves the conversion efficiency of magnetism and electricity, reduces the number of turns for increasing the inductance coil, reduces the coil resistance, and prevents efficiency loss due to heat.

In order to check the charging efficiency of the magnetic material, magnetic permeability according to the thickness of the magnetic material and charging efficiency of the ferrite may be compared. The higher the magnetic permeability is, the higher the charging efficiency becomes, and the thicker the thickness is, the higher the charging efficiency becomes.

However, since a magnetic material for an existing wireless charging system mainly uses a ferrite composite in the form of a thin plate, there are problems that the charging efficiency according to the thickness is low, the cost of the material itself is high, and the cost increases as the material thickness increases.

Therefore, the need to develop such a magnetic material capable of significantly reducing the cost while simultaneously improving magnetic properties as a magnetic material for the wireless charging system is gradually increasing in proportion to the speed of adopting the wireless charging technology to vehicles.

Further, the magnetic material for the existing wireless charging system is pressed by using a powder molding or pressing method. In the powder molding method, a soft magnetic powder is put into a mold and pressed by plastic deformation. At this time, insulation treatment is performed on the surface of the soft magnetic powder due to characteristics of high frequency products. The insulation treatment is usually performed by coating the surface of the powder using a liquid resin. However, when performing the insulation treatment by such a wet method, there is a problem in that detailed process steps are increased, which increases the manufacturing cost and causes the product deviation to occur for each batch.

Further, since, when the powder is molded by such a wet method, the insulating layer coated on the powder surface must not be destroyed, a green compact, i.e., a compacted powdered material, cannot be sintered at high temperatures. Therefore, a product manufactured by such a method has a problem of a low strength.

Although the magnetic material may be manufactured by the injection molding method in addition to the wet powder molding method, the injection molding method itself is not suitable for mass production since the process is complicated and the cost is high.

The above information disclosed in this Background section is only to enhance understanding of the background of the disclosure. Therefore, the Background section may contain information that does not form the prior art that is already known in this country to a person of ordinary skill in the art.

### SUMMARY

The present disclosure is provided to solve the aforementioned problems of the conventional art and provides a magnetic material for a wireless charging system, which can increase charging efficiency by having excellent magnetic properties as a general-purpose material.

Further, the present disclosure provides a method for manufacturing a magnetic material for a wireless charging system, which can improve the strength of a green compact while improving the insulation performance between magnetic powders. A magnetic material of a general-purpose material is directly mixed with a thermosetting resin, pressing is performed, and then heat treatment is performed at a relatively low temperature.

A magnetic material for a wireless charging system according to an aspect of the present disclosure comprises a balance of iron powders and 1-10% by weight of a thermosetting resin. The iron powders may be individually insulated by the thermosetting resin.

In the magnetic material for the wireless charging system, the iron powders may comprise: 0.01% by weight or less (excluding 0% by weight) of carbon (C); 0.03% by weight or less (excluding 0% by weight) of silicon (Si); 0.2% by weight or less (excluding 0% by weight) of manganese (Mn); 0.02% by weight or less (excluding 0% by weight) of phosphorus (P); 0.02% by weight or less (excluding 0% by weight) of sulfur (S); 0.12% by weight or less (excluding 0% by weight) of oxygen (O); and other unavoidable impurities and the remainder of iron (Fe).

Further, the iron powders in the magnetic material for the wireless charging system may have an average particle size of 300 μm or less, more specifically 30 to 200 μm.

In the magnetic material for the wireless charging system, the thermosetting resin may be contained in an amount of 2-5% by weight, and such a thermosetting resin may include any one selected from an epoxy resin, a polyester resin, an acrylic resin, and a mixed resin of the epoxy resin and polyester resin.

Such a magnetic material for the wireless charging system may further comprise a lubricant in an amount of 0.01-1.0% by weight, and such a lubricant may be any one of Ethylene bis stearamide, Kenolube®, or zinc stearate.

A method for manufacturing a magnetic material for a wireless charging system according to another aspect of the present disclosure comprises the steps of: mixing particles of a balance of the iron powders and 1-10% by weight of the thermosetting resin with each other; pressing the mixed particles of the iron powders and thermosetting resin; and subjecting curing heat treatment to the green compact, wherein the iron powders may be individually insulated by the thermosetting resin.

In such a method for manufacturing the magnetic material for the wireless charging system, the iron powders may comprise: 0.01% by weight or less (excluding 0% by weight) of carbon (C); 0.03% by weight or less (excluding 0% by weight) of silicon (Si); 0.2% by weight or less (excluding 0% by weight) of manganese (Mn); 0.02% by weight or less (excluding 0% by weight) of phosphorus (P); 0.02% by weight or less (excluding 0% by weight) of sulfur (S); 0.12% by weight or less (excluding 0% by weight) of oxygen (O); and other unavoidable impurities and the remainder of iron (Fe).

Further, in the method for manufacturing the magnetic material for the wireless charging system, the iron powders have an average particle size of 300 μm or less, more specifically 30-200 μm.

In the method for manufacturing the magnetic material for the wireless charging system, the thermosetting resin may be contained in an amount of 2-5% by weight. Such a thermosetting resin may include any one selected from an epoxy resin, a polyester resin, an acrylic resin, and a mixed resin of the epoxy resin and the polyester resin.

Further, the lubricant may be further contained in an amount of 0.01-1.0% by weight in the step of mixing the iron powders and the thermosetting resin.

The pressing step of the method for manufacturing the magnetic material for the wireless charging system may have a pressing force of 2-13 ton/cm².

Further, the curing heat treatment step of the method for manufacturing the magnetic material for the wireless charging system may have a heat treatment temperature of 150-280° C. and a heat treatment time of 5-30 min.

According to an aspect of the present inventive concept, a magnetic material according to an embodiment of the present disclosure may provide a magnetic material for a wireless charging system, which can increase charging efficiency by having excellent magnetic properties even as a general-purpose material.

According to an aspect of the present inventive concept, the magnetic material according to an embodiment of the present disclosure satisfies the inductance required in the wireless charging system by exhibiting a constant magnetic permeability (inductance) in a high frequency region of 80-120 kHz.

The magnetic material according to an embodiment of the present disclosure may provide a magnetic material for a wireless charging system. The magnetic material simplifies the manufacturing process, has excellent molding strength of the green compact, and allows the manufactured green compact to be homogeneous without a material deviation by mixing iron powders, a magnetic material, and a thermosetting resin, performing pressing, and performing heat treatment at a relatively low temperature.

The magnetic material according to an embodiment of the present disclosure exhibits technical effects that are advantageous in the mass production as it can significantly reduce the cost while satisfying the performance required in a charger by equal or more even as a general-purpose material.

### BRIEF DESCRIPTION OF THE DRAWINGS

FIG. 1 is a schematic view showing the process of pressing a magnetic material for a wireless charging system according to an embodiment of the present disclosure.

FIGS. 2A-2C are a micrograph of a magnetic material manufactured according to the manufacturing method of an embodiment of the present disclosure.

FIG. 3 is a graph showing the strength of the green compact compared to the content of the thermosetting resin with respect to the magnetic material manufactured according to an embodiment of the present disclosure.

FIG. 4 is a graph showing changes in magnetic permeability values (s) for each frequency in the 1 kHz-10 MHz band with respect to the magnetic material manufactured according to an embodiment of the present disclosure.

FIG. 5 is a graph showing changes in magnetic permeability values (p) for each frequency in the 100 kHz-10 MHz band with respect to the magnetic material manufactured according to an embodiment of the present disclosure.

FIG. 6 is a graph showing changes in magnetic permeability values (s) for each frequency in the 1 kHz-10 MHz band compared to the content of the thermosetting resin with respect to the magnetic material manufactured according to an embodiment of the present disclosure.

### DETAILED DESCRIPTION OF THE EMBODIMENTS

The terms first, second, third, and the like are used to describe various parts, components, regions, layers and/or sections, but are not limited thereto. These terms are used only to distinguish one part, component, region, layer or section from other part, component, region, layer, or section. Accordingly, the first part, component, region, layer, or section described below may be referred to as the second part, component, region, layer, or section within the scope that does not depart from the scope of the present disclosure.

The terminologies used herein are only for the purpose of mentioning specific embodiments and are not intended to limit the present disclosure. The singular forms used herein also include the plural forms unless the phrases clearly indicate the opposite. The meaning of “comprising” used in the specification embodies a particular characteristic, region, integer, step, operation, element and/or component. The meaning of “comprising” does not exclude the existence or addition of other characteristic, region, integer, step, operation, element and/or component.

When a part is referred to as being “above” or “on” other part, it may be directly above or on the other part, or another part may be involved therebetween. In contrast, when a part refers to being “directly above” other part, another part is not interposed therebetween.

Further, unless otherwise specified, % means % by weight, and 1 parts per million (ppm) is 0.0001% by weight.

Although not defined differently, all terms including technical and scientific terms used herein have the same meaning as those commonly understood by those of ordinary skill in the art to which the present disclosure pertains. Terms defined in commonly used dictionaries are additionally interpreted as having meanings consistent with the related technical literature and the presently disclosed contents, and unless defined, they are not interpreted in ideal or very formal meanings. When a component, device, element, or the like of the present disclosure is described as having a purpose or performing an operation, function, or the like, the component, device, or element should be considered herein as being “configured to” meet that purpose or perform that operation or function.

Hereinafter, an embodiment of the present disclosure is described with reference to the accompanying drawings.

A magnetic material for a wireless charging system is described below.

According to an aspect of the present inventive concept, a wireless charging system of the present disclosure is comprised of a coil and a magnetic material.

The magnetic material, an embodiment of the present disclosure, comprises iron powders as a main component. The magnetic material plays a role of generating a magnetic field at a specific frequency (80-120 kHz) in order to deliver power to a receiver (cell phone or battery) in the wireless charging system and amplifying the generated magnetic field to transmit it to the receiver. In addition, this magnetic material serves to shield the magnetic field so that the magnetic field does not affect a controller (printed circuit board, i.e., PCB) positioned inside the wireless charging system.

To this end, the magnetic material, according to an embodiment of the present disclosure, is manufactured by mixing and molding iron powders and a thermosetting resin at an appropriate ratio and is easily manufactured even in a three-dimensional shape to satisfy the required inductance. Further, the magnetic material may be formed in a form in which the thermosetting resin flows by curing heat treatment to surround individual iron powder particles, and more completely surrounds and insulates the iron powder particles at room temperature.

First, the iron powders are explained. The iron powders have a composition of a carbon (C) content of 0.01% or less, have ferrite as a main crystal structure, and have ferromagnetic properties. Further, the iron powders have high magnetic permeability and small core loss characteristics at high frequencies and have excellent formability at the same time so that if they are mixed and pressed with an insulating binder, a magnetic material with excellent magnetic properties may be manufactured.

Such iron powders may comprise: 0.01% by weight or less (excluding 0% by weight) of carbon (C); 0.03% by weight or less (excluding 0% by weight) of silicon (Si); 0.2% by weight or less (excluding 0% by weight) of manganese (Mn); 0.02% by weight or less (excluding 0% by weight) of phosphorus (P); 0.02% by weight or less (excluding 0% by weight) of sulfur (S); 0.12% by weight or less (excluding 0% by weight) of oxygen (O); and other unavoidable impurities and the remainder of iron (Fe). General-purpose commercially available iron powders may be used. However, 99.9% or more pure iron powders may also be used depending on the purpose of the wireless charging system.

Such iron powders may be made by various methods and used. Although methods for manufacturing iron powders include a mechanical method such as pulverization, cutting, or atomization, a physical method such as vaporization or condensation, and an electrochemical method such as electrolytic precipitation, any iron powders, no matter how they are manufactured, that do not have a problem in molding the magnetic material can be used. As a method for manufacturing the iron powders by the mechanical method, for example, the powders can be manufactured using atomization. Such atomization is a method of manufacturing iron into the powders by strongly atomizing air or water while outflowing molten iron through a fine hole.

Regardless of by what method the iron powders are manufactured, the manufactured iron powders may have an average particle diameter of 300 μm or less, and more specifically may have an average particle diameter of 30 to 200 μm.

The thermosetting resin used in an embodiment of the present disclosure allows the manufactured magnetic material to have required strength and insulation properties by exhibiting the bonding strength at the same time while insulating respective iron powders from each other through processes of mixing, molding, and heat-treating the thermosetting resin and iron powders. Therefore, the thermosetting resin used in an embodiment of the present disclosure is not particularly limited as long as it can achieve such an effect of the present inventive concept.

Specifically, the thermosetting resin used in an embodiment of the present disclosure may include an epoxy resin, a polyester resin, and an acrylic resin, and may also include a mixture of the epoxy resin and the polyester resin.

In an embodiment of the present disclosure, the iron powders and thermosetting resin are mixed and then pressed. At this time, a small amount of a lubricant is added in order to minimize a damage to the mold while reducing the mutual friction between particles of the iron powders in the pressing process and allowing the iron powders to be uniformly pressed. Therefore, the lubricant used in an embodiment of the present disclosure is not particularly limited as long as it can achieve such an effect of the present inventive concept.

Specifically, the lubricant used in an embodiment of the present disclosure may include Ethylene bis stearamide, Kenolube® commercially available from Hoganas AB, zinc stearate, etc.

Further, the composition ratio of respective components used in the manufacture of the magnetic material, according to an embodiment of the present disclosure, may comprise 1-10% by weight, specifically 2-5% by weight of the thermosetting resin, 0.01-1.0% by weight of the lubricant, and the remainder of the iron powders.

A method for manufacturing a magnetic material for a wireless charging system is described with reference to the accompanying drawings.

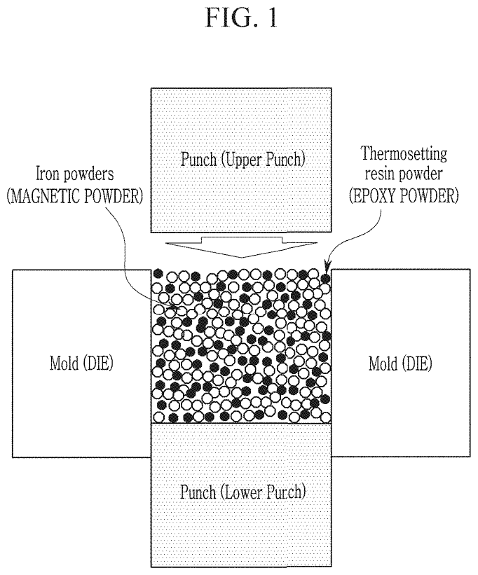

FIG. 1 is a schematic view showing the process of pressing a magnetic material for a wireless charging system according to an embodiment of the present disclosure.

A method for manufacturing a magnetic material for a wireless charging system, according to an embodiment of the present disclosure, may comprise the steps of mixing components constituting the magnetic material, pressing the mixed components, and subjecting curing heat treatment to the green compact at low temperatures.

According to such an embodiment of the present disclosure, insulation treatment for insulating individual iron powders during the manufacturing process is required in order to manufacture a magnetic material. The magnetic material for the wireless charging system exhibits magnetic properties when the surface of each iron powder is insulation-treated due to high frequency characteristics generated by the coil. The magnetic material can be used in a wireless charger only when such an insulating layer should not be destroyed even after a final product is manufactured. Therefore, heat treatment at high temperatures such as sintering cannot be used in the present inventive concept since the thermosetting resin melts and destroys the insulating layer.

Insulation-treating the iron powders in the magnetic material manufacturing of the present disclosure is to insulate the iron powders by melting the thermosetting resin and evenly coating the iron powders in the curing heat treatment process after performing pressing using a solid phase thermosetting resin. Therefore, it is possible to insulation-treat iron powders in a simple manner without the need to pulverize dry and agglomerated particles after classifying a magnetic powder and coating the magnetic powder in a separate process with a liquid paint as in the wet insulation treatment.

First, the step of mixing the respective components constituting the magnetic material in the method for manufacturing the magnetic material for the wireless charging system is described.

For this, iron powders, a thermosetting resin powder, and a small amount of a lubricant are mixed. The iron powders and thermosetting resin powder are mixed to a mixing ratio considering the frequency characteristic of the wireless charger and the strength improvement effect of the green compact.

Next, pressing is performed by putting a mixture in which the iron powders, thermosetting resin, and lubricant are mixed at an appropriate ratio in the same mold as in FIG. 1, and applying a pressing force that is a relatively low pressure (e.g., 4 ton/cm²). At this time, the pressing force may be 2-13 ton/cm² since the higher the pressure is, the higher the molding strength is, and the more the magnetic permeability is improved.

As described above, since a mold of the present disclosure enables molding to be performed even at a relatively low pressure, molding can be performed even with a general-purpose press without requiring an expensive high-pressure molding press. Accordingly, since the replacement cycle of the mold is also lengthened, the mold of the present disclosure can make a certain contribution to lowering the manufacturing cost of the magnetic material.

Then, the green compact is put in a curing furnace and curing heat treatment is performed. At this time, heat treatment is performed at about the temperature and for about a time where the resin can be cured while coating the iron powders by melting the thermosetting resin powder. The heat treatment temperature and time vary depending on the type of the thermosetting resin used and the mixing ratio of the resin, but 5-30 min at 150-280° C. may be used. For example, when using a thermosetting resin of KARUMEL EX8816 (KCC) product in which an epoxy resin and a polyester resin are mixed, the heat treatment temperature and time may be 15 min (±10 min) at 180° C. (±20). Further, it is possible to use heat treatment in the atmospheric pressure as a pressure of the curing furnace.

Since curing heat treatment is carried out at a relatively low temperature in a state in which the iron powders and the thermosetting resin are pressed as described above, the iron powders are not oxidized or nitrified so that the magnetic properties are not deteriorated. Accordingly, subsequent processes including additionally spraying a separate paint to the surface of a green compact are not required.

Therefore, the method for manufacturing the magnetic material for the wireless charging system according to the present disclosure is suitable for mass production, simplifies facility investment for mass production, and enables the treatment to be performed at low temperatures so that the process cost is low, thereby enabling the manufacturing cost to be ultimately lowered.

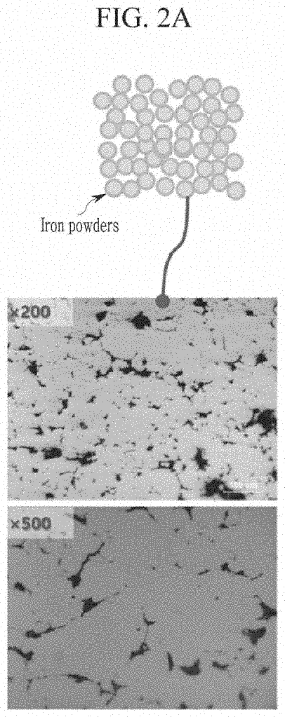

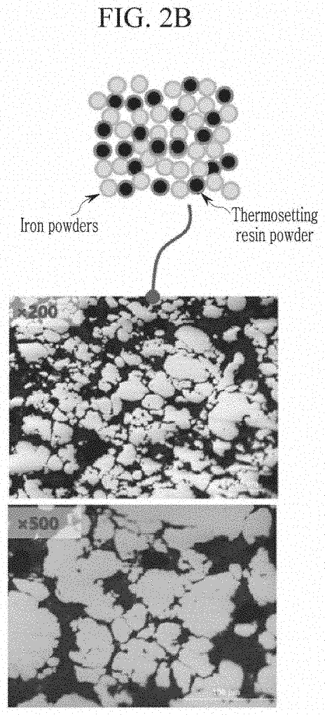

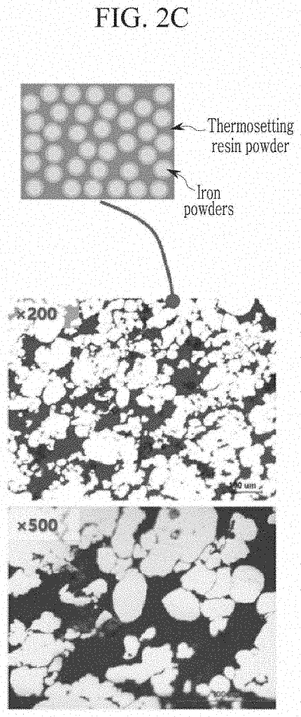

FIGS. 2A-2C are a micrograph of the magnetic material manufactured according to the method for manufacturing the magnetic material for the wireless charging system of the present disclosure.

The iron powders used in FIGS. 2A-2C comprise 0.002% by weight of carbon (C), 0.008% by weight of silicon (Si), 0.11% by weight of manganese (Mn), 0.008% by weight of phosphorus (P), 0.004% by weight of sulfur (S), 0.08% by weight of oxygen (O), and other unavoidable impurities and the remainder of iron (Fe). The iron powders also have a particle size distribution including 2.0% of 80 mesh (180 μm), 9.0% of 100 mesh (150 m), 21.4% of 140 mesh (106 μm), 22.0% of 200 mesh (75 μm), 24.9% of 325 mesh (45 μm), and 20.7% of −325 mesh (−45 μm).

In addition, KARUMEL EX8816 (KCC) product, in which an epoxy resin and a polyester resin were mixed, was used as a thermosetting resin, and Kenolube® of Hoganas AB was used as a lubricant. At this time, the materials were mixed at a mixing ratio of 10% of the thermosetting resin, 0.3% of the lubricant, and a balance of the iron powders.

After putting the magnetic material thus mixed in the same mold as in FIG. 1 and molding it at a pressure of about 4 ton/cm² to make a ring type green compact with a diameter of 12.7 mm and a thickness of 10 mm, the green compact was charged into the curing furnace. Curing heat treatment was carried out at 180° C. for 15 minutes in an atmospheric atmosphere (at an atmospheric pressure).

FIG. 2A is a photomicrograph of a green compact pressed with only iron powders. FIG. 2B is a photomicrograph of a green compact before carrying out curing heat treatment after mixing and molding 10% of the thermosetting resin with the iron powders. FIG. 2C is a photomicrograph of a green compact that has undergone curing heat treatment for the sample of FIG. 2B.

As shown in FIGS. 2A-2C, when the thermosetting resin is not mixed (FIG. 2A), it can be seen that the iron particles are in contact with each other and the particles are not individually insulated, making it difficult to use them as a magnetic material for high frequency. In addition, when the thermosetting resin is added, but curing heat treatment is not performed (FIG. 2B), insulation is made only where thermosetting resin particles are positioned so that the magnetic properties are decreased and the strength of the green compact is also lowered. However, when the thermosetting resin is added and curing heat treatment is carried out (FIG. 2C), it can be seen that the thermosetting resin particles melt and flow and are applied to the surface of the iron particles so that the overall insulation is uniformly made to excellently improve the frequency characteristics and increase the strength of the green compact too.

### EXAMPLE

In order to manufacture the magnetic material for the wireless charging system, iron powders, a thermosetting resin, and a lubricant were prepared and mixed.

First, a powder comprising 0.002% by weight of carbon (C), 0.008% by weight of silicon (Si), 0.11% by weight of manganese (Mn), 0.008% by weight of phosphorus (P), 0.004% by weight of sulfur (S), 0.08% by weight of oxygen (O), and other unavoidable impurities and the remainder of iron (Fe) was used as the iron powders. The iron powders had a particle size distribution including 2.0% of 80 mesh (180 μm), 9.0% of 100 mesh (150 μm), 21.4% of 140 mesh (106 μm), 22.0% of 200 mesh (75 μm), 24.9% of 325 mesh (45 μm), and 20.7% of −325 mesh (−45 μm).

In addition, KARUMEL EX8816 (KCC) product in which an epoxy resin and a polyester resin were mixed was used as the thermosetting resin, and Kenolube® of Hoganas AB was used as the lubricant. At this time, the materials were mixed at a mixing ratio of the thermosetting resin varied within the range of 0-10% by weight, 0.3% by weight of the lubricant, and a balance of the iron powders.

After putting the magnetic material thus mixed in the mold and pressing it at a pressure of about 4 ton/cm² to make a ring type green compact with a diameter of 12.7 mm and a thickness of 10 mm, the green compact was charged into the curing furnace, and curing heat treatment was carried out at 180° C. for 15 minutes in an atmospheric atmosphere.

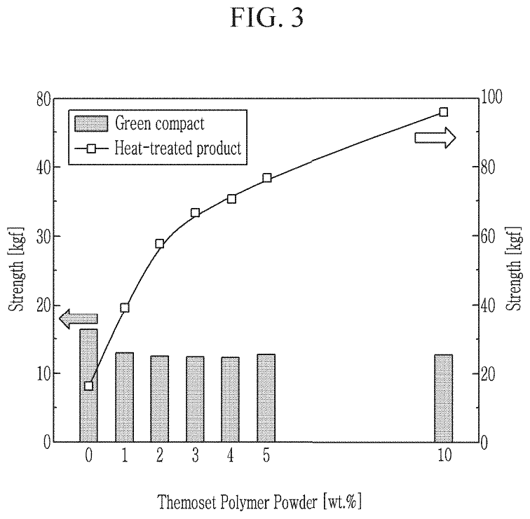

The strength of the green compact relative to the content of the thermosetting resin was measured for the thus-manufactured magnetic material. The results for this are summarized in the graph of FIG. 3.

As can be seen from FIG. 3, when the manufactured magnetic material is subjected to pressing only without being subjected to curing heat treatment, it can be seen that a case of containing the iron powders (0% by weight of the thermosetting resin) has a higher fracture strength than a case of containing the thermosetting resin (1 to 10% by weight). It can be seen that even if the content of the thermosetting resin is changed (1-10% by weight), the change in fracture strength is not large.

However, when the manufactured magnetic material is subjected to curing heat treatment after performing pressing, it can be seen that the fracture strength is higher in all cases containing the thermosetting resin (1-10% by weight) except for the case of containing the iron powders (0% by weight of the thermosetting resin), and it can be seen that the fracture strength is rapidly increased at the boundary of 2% by weight of the content of the thermosetting resin and then is slowly increased at the boundary of 3% by weight.

Therefore, it can be seen that as the addition amount of the thermosetting resin is higher than 1% by weight, the strength of the manufactured magnetic material is improved so that its durability becomes excellent. Therefore, the content of the thermosetting resin may be 1-10% by weight, and the lower limit may be 2% by weight or more.

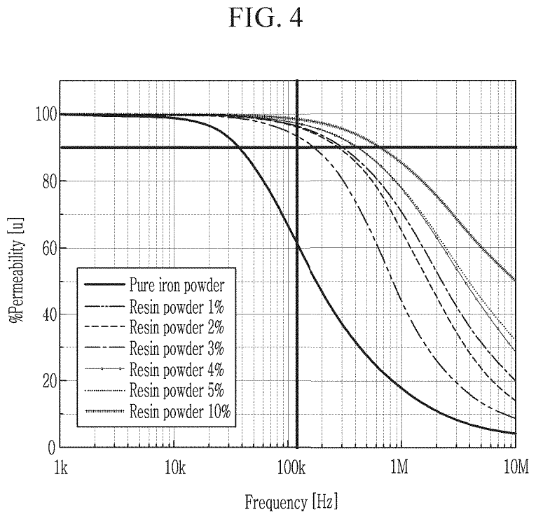

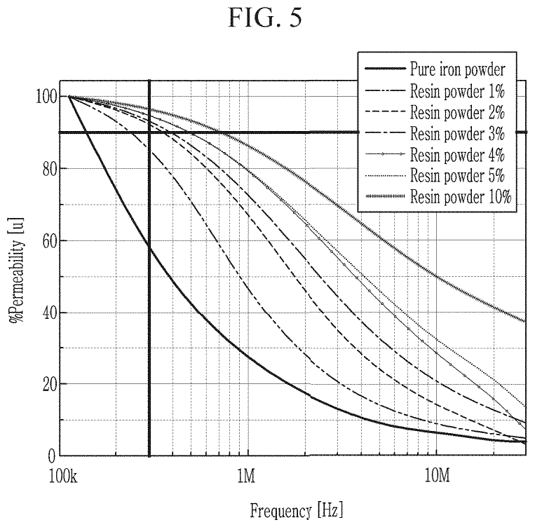

Next, with respect to the magnetic material manufactured as described above, changes in magnetic permeability values (s) for each frequency were measured in order to confirm the high frequency characteristics of the magnetic material compared to the content of the thermosetting resin. The results for this are summarized in the graphs of FIGS. 4-6. Here, the magnetic permeability values in FIGS. 4 and 5 represent the % magnetic permeability values compared to a value obtained by performing 100% conversion based on the content of the thermosetting resin in each sample.

As shown in FIG. 4, it can be seen that changes in magnetic permeability values (p) are within the range of ±10% even if the content of the thermosetting resin is changed in the frequency band of 1 kHz-10 MHz. Therefore, it can be seen that the wireless charging system to which a magnetic material according to an embodiment of the present disclosure is applied can exhibit a constant magnetic permeability value (inductance) even when used in the 80-120 kHz frequency range.

Further, it can be seen that, in the case of iron powders without adding the thermosetting resin to the magnetic material, the magnetic permeability values are low in the 110 kHz frequency region. When the thermosetting resin is added in an amount of at least 1% by weight or more, the magnetic permeability values are good.

In addition, it can be seen that the results similar to those in FIG. 4 are exhibited even in the graph of magnetic permeability values (s) for each frequency in the 100 kHz-10 MHz band shown in FIG. 5.

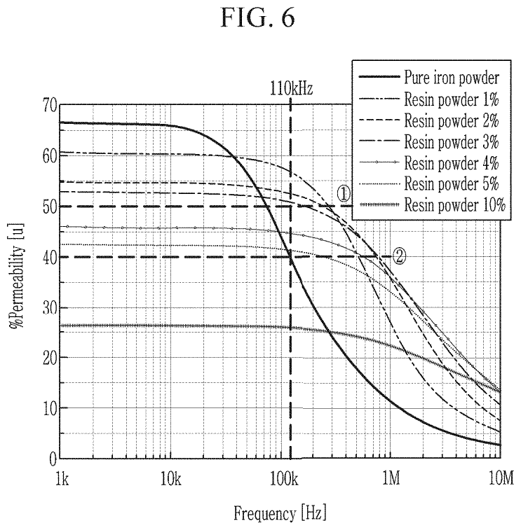

As can be seen from FIG. 6, it can be seen that the magnetic permeability values (p) decrease as the content of the thermosetting resin increases with respect to the magnetic material manufactured according to an embodiment of the present disclosure. However, it can be seen that, even when the content of the thermosetting resin is 10% by weight, the magnetic permeability values in the 110 kHz frequency region exhibit 25μ or more so that it is sufficient for use as a magnetic material for a wireless charger.

Further, it can be seen that, when the content of the thermosetting resin is 1-5% by weight, the magnetic permeability values in the 110 kHz frequency region exhibit 40μ so that it may be used as the magnetic material for the wireless charger. When the content of the thermosetting resin is 1-3% by weight, the magnetic permeability values in the 110 kHz frequency region exhibit 50μ or more so that it may be used as the magnetic material for the wireless charger.

The magnetic material for the wireless charging system according to the present disclosure is not limited to the described embodiments but can be manufactured in various forms which are different from each other. Those of ordinary skill in the art to which the present disclosure pertains should be able to understand that the present disclosure may be implemented in other specific forms without changing the technical spirit or essential features of the present inventive concept. Therefore, it should be understood that the embodiments described above are provided as examples in all respects and are not restrictive.

While this inventive concept has been described in connection with what is presently considered to be practical embodiments, it is to be understood that the inventive concept is not limited to the disclosed embodiments. On the contrary, it is intended to cover various modifications and equivalent arrangements included within the spirit and scope of the appended claims.

What is claimed is:

1. A magnetic material for a wireless charging system, the magnetic material comprising
a balance of iron powders,
1-10% by weight of a thermosetting resin, and
0.01-1.0% by weight of a lubricant, wherein the iron powders are individually insulated by the thermosetting resin.

2. The magnetic material for the wireless charging system of claim 1, wherein:
the iron powders comprise 0.01% by weight or less (excluding 0% by weight) of carbon (C), 0.03% by weight or less (excluding 0% by weight) of silicon (Si), 0.2% by weight or less (excluding 0% by weight) of manganese (Mn), 0.02% by weight or less (excluding 0% by weight) of phosphorus (P), 0.02% by weight or less (excluding 0% by weight) of sulfur (S), 0.12% by weight or less (excluding 0% by weight) of oxygen (O), and other unavoidable impurities and the remainder of iron (Fe).

3. The magnetic material for the wireless charging system of claim 2, wherein:
the iron powders have an average particle size of 300 μm or less.

4. The magnetic material for the wireless charging system of claim 2, wherein:
the iron powders have an average particle size of 30-200 μm.

5. The magnetic material for the wireless charging system of claim 2, wherein:
the thermosetting resin is contained in an amount of 2-5% by weight.

6. The magnetic material for the wireless charging system of claim 2, wherein:
the thermosetting resin is any one of an epoxy resin, a polyester resin, an acrylic resin, and a mixed resin of the epoxy resin and the polyester resin.

7. The magnetic material for the wireless charging system of claim 2, wherein:
the lubricant is any one of Ethylene bis stearamide, Kenolube®, or zinc stearate.

8. A method for manufacturing a magnetic material for a wireless charging system, the method comprising the steps of:
mixing particles of a balance of iron powders,
1-10% by weight of a thermosetting resin, and
0.01-1.0% by weight of a lubricant with each other;
pressing the mixed particles of the iron powders, thermosetting resin, and lubricant; and
subjecting curing heat treatment to a green compact,
wherein the iron powders are individually insulated by the thermosetting resin.

9. The method of claim 8, wherein:
the iron powders comprise 0.01% by weight or less (excluding 0% by weight) of carbon (C), 0.03% by weight or less (excluding 0% by weight) of silicon (Si), 0.2% by weight or less (excluding 0% by weight) of manganese (Mn), 0.02% by weight or less (excluding 0% by weight) of phosphorus (P), 0.02% by weight or less (excluding 0% by weight) of sulfur (S), 0.12% by weight or less (excluding 0% by weight) of oxygen (O), and other unavoidable impurities and the remainder of iron (Fe).

10. The method of claim 9, wherein:
the iron powders have an average particle size of 300 μm or less.

11. The method of claim 9, wherein:
the iron powders have an average particle size of 30-200 μm.

12. The method of claim 9, wherein:
the thermosetting resin is contained in an amount of 2-5% by weight.

13. The method of claim 9, wherein:
the thermosetting resin is any one of an epoxy resin, a polyester resin, an acrylic resin, and a mixed resin of the epoxy resin and the polyester resin.

14. The method of claim 9, wherein:
the pressing step has a pressing force of 2-13 ton/cm².

15. The method of claim 9, wherein:
the curing heat treatment step has a heat treatment temperature of 150-280° C. and a heat treatment time of 5-30 min.
